(19) United States
(12) Patent Application Publication
(10) Pub. No.: US 2008/0034962 A1
(43) Pub. Date: Feb. 14, 2008

(54) Air cleaner and air cleaner state backup

(75) Inventor: Bruce Kiern, Gulfport, MS (US)

Correspondence Address: THE OLLILA LAW GROUP LLC, 2060 BROADWAY, SUITE 300, BOULDER, CO, 80302, US

(73) Assignee: Oreck Holdings, LLC

(21) Appl. No.: 11/502,661

(22) Filed: Aug. 10, 2006

(51) Int. Cl. B01D 46/00

(52) U.S. Cl. 95/1; 96/417; 55/471; 96/109

(57) ABSTRACT

An air cleaner is provided according to the invention. The air cleaner includes a main power source, a backup power source, a state detector configured to detect a state of an air cleaner component, and a state memory element coupled to the state detector. The state memory element is configured to transfer a current state in the state memory element to a control circuit: using main electrical power from a main power source, receive the state in the state memory element from the state detector when the state memory element is receiving backup electrical power from a backup power source, and store the state in the state memory element using the backup electrical power.

### TECHNICAL FIELD

The present invention relates to an air cleaner, and more particularly, to an air cleaner and air cleaner state backup.

### BACKGROUND OF THE INVENTION

Air cleaners are widely used in home and office settings for cleaning the air. An air cleaner can filter the air in order to remove airborne contaminants. An air cleaner can therefore include any type of mechanical filter element comprising a mesh, a weave, a foam, etc. An air cleaner can include an odor absorber element that removes odor-causing particles from the air stream. An air cleaner can further include electrical air cleaning components, such as a collector cell that removes dirt and debris from the airflow of the air cleaner. A collector cell can include an ionizer and/or an electrostatic precipitator.

An air cleaner also includes some manner of air moving device that creates an airflow through the filter element and/or electrical air cleaning components. The air moving device typically includes several speed settings that allow the user to control the level of operation of the air cleaner. The user can manipulate controls provided through a control panel in order to select from available operating features or settings.

In use, the air cleaning components of the air cleaner can be used for specified times before they require cleaning or replacement. The air cleaner may therefore track and record operational times, such as time periods when the air moving device is operating and the air cleaning components are in position. The tracking and recording can be conducted using corresponding air cleaning component states. A state can comprise inserted and non-inserted states, for example. However, there is a need to retain an air cleaning component state over removal or loss of electrical power.

### SUMMARY OF THE INVENTION

An air cleaner is provided according to the invention. The air cleaner comprises a main power source, a backup power source, a state detector configured to detect a state of an air cleaner component, and a state memory element coupled to the state detector. The state memory element is configured to transfer a current state in the state memory element to a control circuit using main electrical power from a main power source, receive a state in the state memory element from the state detector when the state memory element is receiving backup electrical power from a backup power source, and store the state in the state memory element using the backup electrical power.

An air cleaner state backup method is provided according to an embodiment of the invention. The method comprises transferring a current state in a state memory element of an air cleaner to a control circuit using main electrical power from a main power source, receiving a state in the state memory element from a state detector when the state memory element is receiving backup electrical power from a backup power source, and storing the state in the state memory element using the backup electrical power.

An air cleaner state backup method is provided according to an embodiment of the invention. The method comprises transferring a current collector cell state in a collector cell state memory element of an air cleaner to a control circuit using main electrical power from a main power source and transferring a current odor absorber state in an odor absorber state memory element to the control circuit using the main electrical power. The method further comprises receiving a collector cell state in the collector cell state memory element from a collector cell state detector when the collector cell state memory element is receiving backup electrical power from a backup power source and receiving an odor absorber state in the odor absorber state memory element from an odor absorber state detector when the odor absorber state memory element is receiving the backup electrical power. The method further comprises storing the collector cell state in the collector cell state memory element using the backup electrical power and storing the odor absorber state in the odor absorber state memory element using the backup electrical power.

### BRIEF DESCRIPTION OF THE DRAWINGS

The same reference number represents the same element on all drawings.

FIG. 1 shows an air cleaner according to an embodiment of the invention.

FIG. 2 is a flowchart of an air cleaner state backup method according to an embodiment of the invention.

FIG. 3 is a flowchart of an air cleaner state backup method according to an embodiment of the invention.

FIG. 4 is a flowchart of an air cleaner state backup method according to an embodiment of the invention.

### DETAILED DESCRIPTION OF THE INVENTION

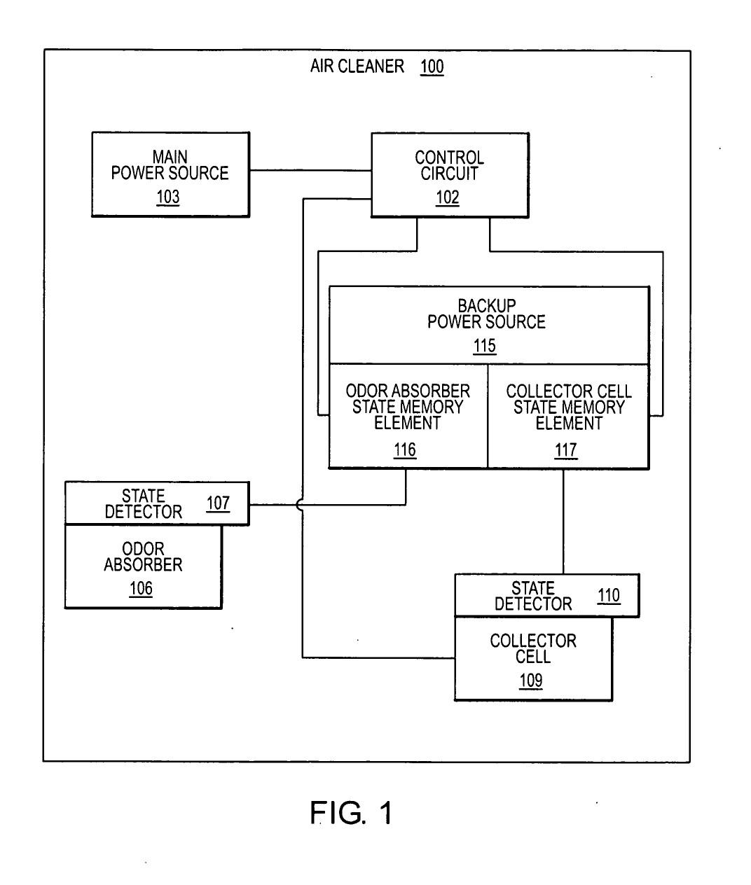

FIGS. 1-4 and the following descriptions depict specific embodiments to teach those skilled in the art how to make and use the best mode of the invention. For the purpose of teaching inventive principles, some conventional aspects have been simplified or omitted. Those skilled in the art will appreciate variations from these embodiments that fall within the scope of the invention. Those skilled in the art will also appreciate that the features described below can be combined in various ways to form multiple variations of the invention. As a result, the invention is not limited to the specific embodiments described below, but only by the claims and their equivalents.

FIG. 1 shows an air cleaner 100 according to an embodiment of the invention. The air cleaner 100 includes a control circuit 102, a main power source 103, an odor absorber 106, and a collector cell 109. In one embodiment, the odor absorber 106 includes an odor absorber state detector 107 and the collector cell 109 includes a collector cell state detector 110. In addition, the air cleaner 100 further includes a backup power source 115, an odor absorber state memory element 116, and a collector cell state memory element 117.

The backup power source 109 is independent of the operational power source 108. The backup power source 109 in one embodiment comprises a suitable battery power source or other independent power source.

The control circuit 102 is connected to the main power source 103, to the collector cell 109, and to the collector cell state detector 110. In addition, the control circuit 102 is connected to the odor absorber state memory element 116 and the collector cell state memory element 117.

The state memory elements 116 and 117 receive and store air cleaning component states, such as a collector cell state and an odor absorber state, for example. In one embodiment, a state memory element comprises a low current flip-flop. The state memory element changes state when the corresponding air cleaning element is removed. For example, in one embodiment the state memory element will contain a logic 1 if the air cleaning component was removed or a logic 0 otherwise. In this embodiment, a logic 1 value can be used to reset a corresponding operational timer. Advantageously, this reset feature can eliminate the need for the user to press and hold a button to reset the timer.

One or both of the odor absorber state memory element 116 and the collector cell state memory element 117 can be configured to transfer a current state in a state memory element of an air cleaner to a control circuit using main electrical power from a main power source, receive a state in the state memory element from a state detector when the state memory element is receiving backup electrical power from a backup power source, and store the state in the state memory element using the backup electrical power.

The state can comprise any desired state. In one embodiment, the state comprises an odor absorber state, a collector cell state, or both. However, other states are contemplated and are within the scope of the description and claims.

The control circuit 102 controls operations of the air cleaner 100, including operating an air moving device (not shown) and operating the collector cell 109. In addition, the control circuit 102 records operating times of the odor absorber 106 and the collector cell 109, for example. Subsequently, the control circuit 102 can generate an indication to a user when either component requires maintenance, such as cleaning or replacement. The maintenance can be based on hours of operation of the component, such as hours of operation of the air moving device while the respective component is in place in the air cleaner 100.

The control circuit 102 in the embodiment shown can distribute main electrical power to the collector cell 109. Alternatively, instead of the control circuit 102 being located between the main power source 103 and other components, the control circuit can send signals or commands that control the supply of the main electrical power at individual components.

The main electrical power can be removed when the main power source 103 is disabled. For example, a user can unplug the air cleaner 100 from a 120 volt electrical socket. In addition, the main electrical power can be removed when an access door or panel is opened, interrupting the main electrical power through a safety switch(es) or other safety system. Further, the main electrical power can be removed when the collector cell 109 is removed from a receptacle in the air cleaner 100, interrupting the main electrical power through a safety switch(es) or other safety system.

The states of various air cleaning components and their hours of operation must be recorded in order that the air cleaner 100 can notify the user of a need for cleaning or replacement. However, the main electrical power can be removed from the air cleaner 100 at times, as discussed above. Therefore, tracking and recording the removal and/or installation of air cleaning components is problematic. Supply of battery power to the control circuit 102 will result in an unsatisfactorily short battery life. Instead, the backup power source 115 can provide the backup electrical power only to predetermined memory elements. Consequently, the life of the backup power source 115 is greatly extended. When the main electrical power is restored, the information in the memory elements is transferred to the control circuit 102.

The odor absorber 106 comprises a component that removes odors from an airstream of the air cleaner 100. The odor absorber 106 includes an odor absorber element, wherein the odor absorber element requires replacement after a predetermined operational time period. The operational time is recorded by the control circuit 102.

The odor absorber state detector 107 detects when an odor absorber element is inserted and removed. The odor absorber state detector 107 can comprise a switch, sensor, or other device that detects a presence or absence of a corresponding odor absorber element. The odor absorber state detector 107 provides an odor absorber state signal to the odor absorber state memory element 116, which in turn provides the odor absorber state signal to the control circuit 102. Consequently, the control circuit 102 can time the period between insertion and removal of the odor absorber element.

The odor absorber state memory element 116 can receive main electrical power through the control circuit 102. Therefore, when the odor absorber state memory element 116 is receiving main electrical power, the odor absorber state memory element 116 will receive and store an up-to-date odor absorber state. However, if the main electrical power is not currently being supplied, then the odor absorber state memory element 116 needs an alternative power source in order to store the state of the odor absorber 106. As a result, the odor absorber state memory element 116 receives backup electrical power from the backup power source 115 when not receiving the main electrical power. The odor absorber state memory element 116 can therefore store the odor absorber state until the control circuit 102 again receives the main electrical power. Subsequently, the odor absorber state will be transferred to the control circuit 102 after the main electrical power is restored.

Likewise, the collector cell state detector 110 detects when the collector cell 109 is installed or removed. The collector cell state detector 110 can comprise a switch, sensor, or other device that detects a presence or absence of the collector cell 109. The state detector 110 provides a collector cell state signal to the collector cell state memory element 117, which in turn provides the collector cell state signal to the control circuit 102. The control circuit 102 can therefore time the period between insertion and removal of the collector cell 109.

When the collector cell state memory element 117 is receiving the main electrical power, the collector cell state memory element 117 will receive and store an up-to-date collector cell state. However, if the main electrical power is not currently being supplied, then the collector cell state memory element 117 needs an alternative power source in order to store the state of the collector cell 109. As a result, the collector cell state memory element 117 receives backup electrical power from the backup power source 115 when not receiving the main electrical power. The collector cell state memory element 117 can therefore store the collector cell state until the control circuit 102 again receives the main electrical power. Subsequently, the collector cell state will be transferred to the control circuit 102 after the main electrical power is restored.

In some embodiments, the backup power source 115 will provide electrical power only if the voltage level of the main power source 103 drops below the voltage level of the backup power source 115. Therefore, during brownout conditions or transient voltage drops of the main power source 103, the backup power source 115 will temporarily provide electrical power to the odor absorber state memory element 116 and to the collector cell state memory element 117. Advantageously, the backup power source 115 will retain a state or states over any manner of power loss or power fault, including when a state is constant or where a state is changing.

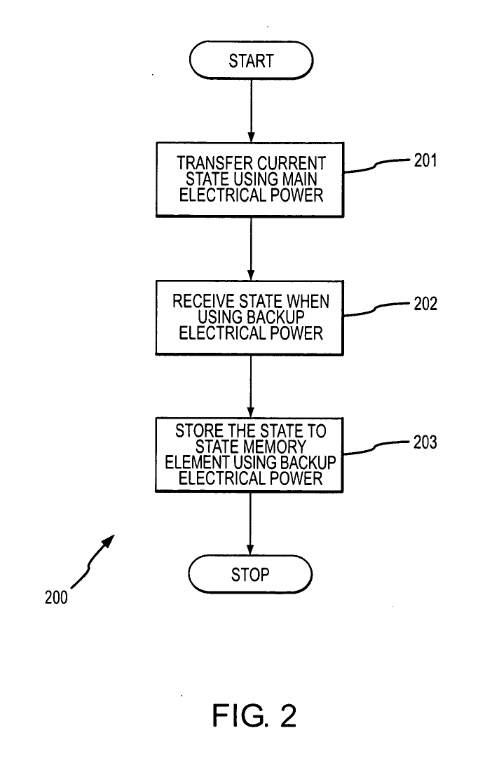

FIG. 2 is a flowchart 200 of an air cleaner state backup method according to an embodiment of the invention. In step 201, a current state is transferred to the control circuit 102 using main electrical power. This step occurs under normal operation of the air cleaner 100 when the main power source 103 is providing the main electrical power to other components of the air cleaner 100. The state can comprise any desired state. In one embodiment, the state comprises an odor absorber state, a collector cell state, or both. However, other states are contemplated and are within the scope of the description and claims.

In step 202, a state is received when using backup electrical power. The state is received in a state memory element from a state detector. The state can comprise a new state or can remain unchanged.

The state has been stored and maintained up to this point using the main electrical power, when available, and then the backup electrical power when the main electrical power was removed. The main electrical power can be removed in any manner. The backup electrical power, when it occurs, maintains the current state. If the state changes, the new state is maintained by the backup electrical power. Therefore, if an air cleaning component is removed and/or installed while the main electrical power is removed, the removal/installation will be recorded.

In step 203, the state is stored to the state memory element using the backup electrical power. The state is maintained in the state memory element using the backup electrical power. The state is maintained using the backup electrical power until the main electrical power is restored. The state can be transferred to the control circuit 102 when the main electrical power is restored. As a result, the control circuit 102 will not experience a loss of state or an improper change of state. The control circuit 102 can therefore accurately maintain an operational timer for the state and can track operational use of the corresponding air cleaner component.

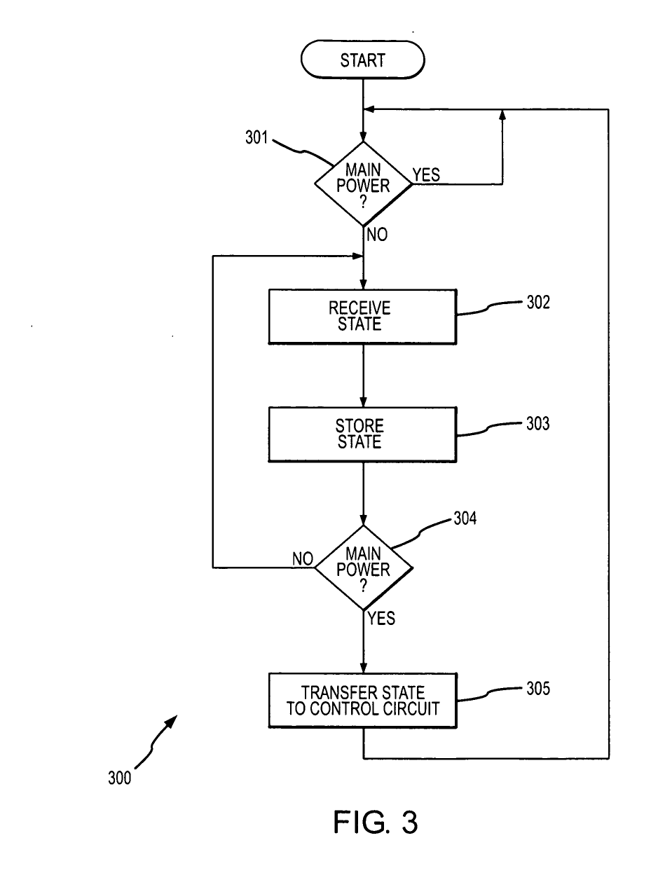

FIG. 3 is a flowchart 300 of an air cleaner state backup method according to an embodiment of the invention. In step 301, if the main electrical power is being provided, then the method loops back on itself and repeats step 301. If the main electrical power has been removed, however, then the method proceeds to step 302.

In step 302, a state is received. The state can comprise a new state or an existing state. The state is received during a period when main electrical power is not being provided.

In step 303, the state is stored to the state memory element. Alternatively, if no new state has occurred, then the current state is maintained in the state memory element.

In step 304, if the main electrical power has been restored, then the method proceeds to step 305. Alternatively, if the backup electrical power is still being supplied, then the method loops back to step 302. As a result, as long as the backup electrical power is being supplied, the state memory element will be kept current and will maintain the current state.

In step 305, after main electrical power has been restored, the state is transferred to the control circuit 102. As a result, the control circuit 102 will not experience a loss of state or an improper change of state. The control circuit 102 can therefore accurately maintain an operational timer for the state and can track operational use of the corresponding air cleaner component.

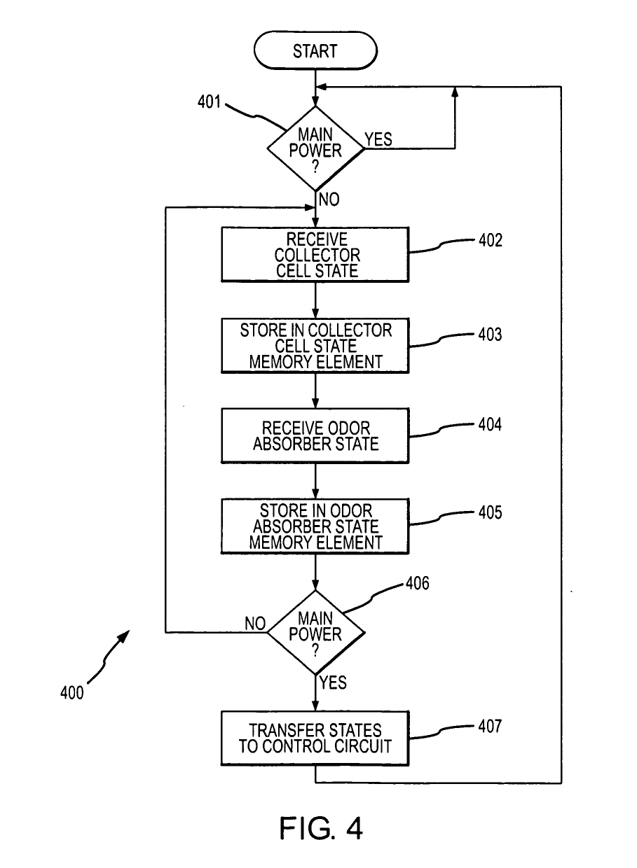

FIG. 4 is a flowchart 400 of an air cleaner state backup method according to an embodiment of the invention. In step 401, if the main electrical power is being provided, then the method loops back on itself and repeats step 401. If the main electrical power has been removed, however, then the method proceeds to step 402, as previously discussed.

In step 402, a collector cell state is received. The collector cell state is received during a period when the main electrical power is not being provided. The collector cell state may be new or may remain unchanged, as previously discussed. As a result, a collector cell operational use timer is accurately maintained.

In step 403, the collector cell state is stored to the collector cell state memory element. The storing is accomplished using the backup electrical power.

In step 404, an odor absorber state is received. The odor absorber state is received when the main electrical power is not being provided. The odor absorber state may be new or may remain unchanged, as previously discussed. As a result, an odor absorber operational use timer is accurately maintained.

In step 405, the odor absorber state is stored to the odor absorber state memory element. The storing is accomplished using the backup electrical power.

In step 406, if the main electrical power has been restored, then the method proceeds to step 305. Alternatively, if the backup electrical power is still being supplied, then the method loops back to step 302. As a result, as long as the backup electrical power is being supplied, the state memory element will be kept current and will maintain the current state.

In step 407, after the main electrical power has been restored, the states are transferred to the control circuit 102. As a result, the control circuit 102 will not experience a loss of state or an improper change of state. The control circuit 102 can therefore accurately maintain operational timers for the states and can track operational use of the corresponding air cleaner components.

What is claimed is:

1. An air cleaner, comprising:
a main power source;
a backup power source;
a state detector configured to detect a state of an air cleaner component; and
a state memory element coupled to the state detector, with the state memory element being configured to transfer a current state in the state memory element to a control circuit using main electrical power from a main power source, receive the state in the state memory element from the state detector when the state memory element is receiving backup electrical power from a backup power source, and store the state in the state memory element using the backup electrical power.

2. The air cleaner of claim 1, further comprising subsequently transferring the state to the control circuit when the main electrical power is restored to the state memory element.

3. The air cleaner of claim 1, with the state received from the state detector comprising either a new state or an existing state.

4. The air cleaner of claim 1, with the state comprising a collector cell state and with the state memory element comprising a collector cell state memory element.

5. The air cleaner of claim 1, with the state comprising an odor absorber state and with the state memory element comprising an odor absorber state memory element.

6. The air cleaner of claim 1, with the state comprising a collector cell state and an odor absorber state and with the state memory element comprising a collector cell state memory element and an odor absorber state memory element.

7. The air cleaner of claim 1, with the state memory element being further configured to transfer a collector cell state in a collector cell state memory element of the air cleaner to the control circuit using main electrical power from a main power source, transfer an odor absorber state in an odor absorber state memory element of the air cleaner to the control circuit using the main electrical power, receive a collector cell state in the collector cell state memory element when the collector cell state memory element is receiving backup electrical power from a backup power source, receive an odor absorber state in the odor absorber state memory element when the odor absorber state memory element is receiving the backup electrical power, store the collector cell state in the collector cell state memory element using the backup electrical power, and store the odor absorber state in the odor absorber state memory element using the backup electrical power.

8. The air cleaner of claim 7, with the state memory element being further configured to subsequently transfer the collector cell state to the control circuit when the main electrical power is restored to the collector cell state memory element and transfer the odor absorber state to the control circuit when the main electrical power is restored to the odor absorber state memory element.

9. An air cleaner state backup method, comprising:
transferring a current state in a state memory element of an air cleaner to a control circuit using main electrical power from a main power source;
receiving a state in the state memory element from a state detector when the state memory element is receiving backup electrical power from a backup power source; and
storing the state in the state memory element using the backup electrical power.

10. The method of claim 9, further comprising subsequently transferring the state to the control circuit when the main electrical power is restored to the state memory element.

11. The method of claim 9, with the state received from the state detector comprising either a new state or an existing state.

12. The method of claim 9, with the state comprising a collector cell state and with the state memory element comprising a collector cell state memory element.

13. The method of claim 9, with the state comprising an odor absorber state and with the state memory element comprising an odor absorber state memory element.

14. The method of claim 9, with the state comprising a collector cell state and an odor absorber state and with the state memory element comprising a collector cell state memory element and an odor absorber state memory element.

15. The method of claim 9, with the transferring, receiving, and storing further comprising:
transferring a current collector cell state in a collector cell state memory element of the air cleaner to the control circuit using the main electrical power;
transferring a current odor absorber state in an odor absorber state memory element of the air cleaner to the control circuit using the main electrical power;
receiving a collector cell state in the collector cell state memory element from a collector cell state detector when the collector cell state memory element is receiving the backup electrical power;
receiving an odor absorber state in the odor absorber state memory element from an odor absorber state detector when the odor absorber state memory element is receiving the backup electrical power;
storing the collector cell state in the collector cell state memory element using the backup electrical power; and
storing the odor absorber state in the odor absorber state memory element using the backup electrical power.

16. The method of claim 15, further comprising:
subsequently transferring the collector cell state to the control circuit when the main electrical power is restored to the collector cell state memory element; and
transferring the odor absorber state to the control circuit when the main electrical power is restored to the odor absorber state memory element.

17. An air cleaner state backup method, comprising:
transferring a current collector cell state in a collector cell state memory element of an air cleaner to a control circuit using main electrical power from a main power source;
transferring a current odor absorber state in an odor absorber state memory element of the air cleaner to the control circuit using the main electrical power;
receiving a collector cell state in the collector cell state memory element from a collector cell state detector when the collector cell state memory element is receiving backup electrical power from a backup power source;
receiving an odor absorber state in the odor absorber state memory element from an odor absorber state detector when the odor absorber state memory element is receiving the backup electrical power;
storing the collector cell state in the collector cell state memory element using the backup electrical power; and
storing the odor absorber state in the odor absorber state memory element using the backup electrical power.

18. The method of claim 17, further comprising:
subsequently transferring the collector cell state to the control circuit when the main electrical power is restored to the collector cell state memory element; and
transferring the odor absorber state to the control circuit when the main electrical power is restored to the odor absorber state memory element.

19. The method of claim 17, with the collector cell state received from the collector cell state detector comprising either a new collector cell state or an existing collector cell state and with the odor absorber state received from the odor absorber state detector comprising either a new odor absorber state or an existing odor absorber state.
